(19) United States
(12) Patent Application Publication
(10) Pub. No.: US 2008/0220852 A1
(43) Pub. Date: Sep. 11, 2008

(54) Gaming Machine with a Game Feature

(76) Inventor: Scott Olive, Lane Cove (AU)

Correspondence Address: MCANDREWS HELD & MALLOY, LTD, 500 WEST MADISON STREET, SUITE 3400, CHICAGO, IL, 60661, US

(21) Appl. No.: 12/064,484

(22) PCT Filed: Jul. 17, 2006
(86) PCT No.: PCT/AU2006/001005

§ 371 Date: Feb. 22, 2008

(30) Foreign Application Priority Data
Aug. 23, 2005 (AU) 2005904573

(51) Int. Cl. A63F 9/24; A63F 11/00; A63F 13/08; A63F 13/02; A63F 13/12

(52) U.S. Cl. 463/21; 463/27; 463/31; 463/42; 463/43

(57) ABSTRACT

A gaming machine having a display and a game controller arranged to control images displayed on the display. The game controller is arranged to play a game wherein symbols are randomly selected from a set of symbols, and selected symbols are displayed on the display and, if a winning combination of symbols results, the machine awards a prize. The range of symbols includes at least one first symbol and at least one second symbol. When the first and second symbols are displayed together a feature event is awarded by the game controller. The feature event when played results in one of a plurality of feature outcomes. The game controller is arranged during the feature event to animate the first and second symbols on the display to give the appearance of interaction between the first and second symbols, there being a plurality of different possible interactions which reflect the different feature outcomes.

### FIELD OF THE INVENTION

The present invention relates to a gaming machine. In particular, although not exclusively, the invention relates to gaming machines of the type generally referred to as slot machines, fruit machines or poker machines. The invention also relates to a program for controlling a gaming machine and a data storage means.

### BACKGROUND OF THE INVENTION

Players who regularly play gaming machines, quickly tire of particular games and it is therefore necessary for manufacturers of gaming machines to come up with either innovative game features that add interest to the games provided on such machines, or provide new games in order to keep the players amused and willing to continue playing gaming machines.

The gaming machine market has experienced considerable growth and there is intense competition between manufacturers of gaming machines to supply the various existing and new venues. Clearly the revenue raised by an operator of a particular venue depends on the amount of money wagered. The amount of money wagered on a particular machine is related to the popularity of the machine. Thus when selecting a supplier of gaming machines, the operator of the venue often pays close attention to the popularity of the various games with their patrons.

Therefore, gaming machine manufacturers are keen to devise games which are popular with players, as a mechanism for improving sales.

In particular, manufacturers regularly devise new games or game features which have not previously been seen on slot machines, in order to stimulate renewal of player interest.

The two most popular types of gaming machine either offer card games, particularly poker and variations of that game, or are machines of the traditional, and somewhat confusingly named, poker machine style (also known as fruit machines) in which the display means comprises a video simulation of set of rotatable reels, each carrying a plurality of symbols.

The present invention relates to a game feature which can be used to give added player interest to games.

The foregoing prior art discussion does not necessarily amount to a description of common general knowledge.

### SUMMARY OF THE INVENTION

In accordance with a first aspect of the present invention there is provided a gaming machine having a display and a game controller arranged to control images displayed on the display, the game controller being arranged to play a game wherein symbols are randomly selected from a set of symbols, and selected symbols are displayed on the display means and, if a winning combination of symbols results, the machine awards a prize, and wherein the range of symbols includes at least one predetermined first symbol and at least one predetermined second symbol, such that on the selection and display of the first and second symbols in a predetermined manner, a feature event is awarded, the feature event being adapted to result in one of a plurality of feature outcomes, the game controller being arranged during the feature event to animate the first and second symbols on the display to give the appearance of interaction between the first and second symbols, there being a plurality of different interactions which reflect different feature outcomes.

The gaming machine may include player interaction means operable to initiate, or for intervention during, the feature event. The player interaction means may initiate or cause resumption of interaction between the first and second symbols, giving the player the sense that they can affect or control the outcome of the feature event.

One feature outcome may be a jackpot with a constantly varying amount. The jackpot may progressively increase as the player continues to play the machine i.e. a progressive jackpot. As such, the machine may be a stand alone progressive machine. Alternatively, the progressive jackpot could be linked via a central jackpot controller to other machines. One feature outcome might be the award of a feature prize of a predetermined amount.

The feature outcomes may be randomly selected. Where the feature outcome is randomly selected, the odds of winning each possible feature outcome may vary as determined by a feature outcome weighting table.

The animation may give the appearance of requiring an element of skill in order to be successful. For example, where the first symbol is an archer, the second symbol may comprise a target with a number of zones corresponding to the range of possible feature outcomes. An arrow released by the archer will strike the zone which corresponds to the feature outcome which the game controller has selected to be awarded. For example, if the game controller has determined that the highest feature outcome is to be awarded, then the visual interaction may show the arrow being, released by the archer and hitting the bullseye of the target.

As mentioned above, the gaming machine may facilitate player interaction in the feature event. The player interaction means may require player interaction to initiate animation of the feature event. Alternatively, the player interaction means may affect the timing of some part of the animation. For example, the player interaction may determine the timing of the release of the arrow by the archer. Optionally, the player interaction could also affect direction and speed of the animation. In a preferred embodiment, the player interaction will have no bearing on the selection of the feature prize. In an alternative embodiment, the outcome of the feature event and the awarded feature prize could be determined or influenced by the player interaction.

The first and second symbols may visually interact by there being a departing object which departs from the first symbol and arrives at the second symbol. In particular, the first symbol may animate to show the release of a projectile while the second symbol animates to show the effect of the arriving projectile. The second symbol preferably comprises a target with a range of target zones, each having a different outcome associated with it. The target may comprise a series of concentric rings, each ring defining a separate target zone. The archer and target example has already been set out above. However other interactive animations are possible including a discus thrower which throws a discus which lands at a selected one of possible distances. As another example, a bride may throw a bouquet which is selectively caught or dropped by a bridesmaid. The above examples represent only a few examples of almost limitless possible visual interactions.

The present invention is applicable to video gaming machines of the traditional poker style (also known as slot machines or fruit machines) in which the display means comprises a video simulation of a set of rotatable reels, each carrying a plurality of symbols. The invention is equally applicable to video draw poker machines in which a poker hand is displayed on the screen, the cards of the hand being selected from a standard 52 or 53 card deck. Preferably there are multiple pay lines. For example, where there are three pay lines there will be a three row by five column symbol display. In order for the feature event to be awarded, the first and second symbols may be disposed in predetermined locations such as reels 1 and 5 on the same row.

One or both of the first and second symbols may be wild-card symbols. The prize awarded may be paid on any of the combinations of symbols displayed including the wild-card symbols, prior to the feature event. The appearance of the first and second symbols may each occur at random, according to predetermined probabilities.

In accordance with a second aspect of the invention, there is provided a software program configured to control the operation of a game played on a gaming machine, the gaming machine having a display and a game controller arranged to control images displayed on the display, the game controller being arranged to play a game wherein symbols are randomly selected from a set of symbols, and selected symbols are displayed on the display means and, if a winning combination of symbols results, the machine awards a prize, and wherein the range of symbols includes at least one predetermined first symbol and at least one predetermined second symbol, such that on the selection and display of the first and second symbols in a predetermined manner, a feature event is awarded, the feature event being adapted to result in one of a plurality of feature outcomes, the game controller being arranged during the feature event to animate the first and second symbols on the display to give the appearance of interaction between the first and second symbols, there being a plurality of different interactions which reflect different feature outcomes.

Any of the features described above in connection with the first aspect of the invention, may be applied to the second aspect.

In accordance with a third aspect of the invention, there is provided data storage means storing thereon a program of the type described above. The data storage means can include one or more of the following types of data storage: RAM, ROM, programmable ROM, EPROM, or the like.

As used herein, the term “comprise” and variations of the term, such as “comprising”, “comprises” and “comprised”, are not intended to exclude other additives, components, integers or steps.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

The invention consists in the foregoing and also envisages constructions of which the following gives examples.

### BRIEF DESCRIPTION OF THE DRAWINGS

In order that the invention may be fully understood, one embodiment will now be described by way of example with reference to the drawings, in which:

FIG. 1 illustrates a gaming machine with a video simulation of a rotating reels display according to a first embodiment of the present invention;

FIG. 2 illustrates a schematic block diagram of a control circuit of the gaming machine of FIG. 1;

FIG. 3 illustrates an upper video screen or a top box for the gaming machine of FIG. 1;

FIG. 4 illustrates a second or lower screen for the gaming machine of FIG. 1;

FIGS. 5 to 7 illustrate the progressive animation of symbols on the screen of FIG. 4;

FIG. 8 illustrates the top box corresponding to FIG. 3, except with an adjusted major jackpot amount;

FIG. 9 illustrates the second screen corresponding to FIG. 2, except with an adjusted credit meter; and

FIG. 10 is a flow chart of the process followed by the game control means.

### DETAILED DESCRIPTION OF THE EMBODIMENT

In the following detailed description the methodology of the embodiment will be described, and it is to be understood that it is within the capabilities of the non-inventive worker in the art to introduce the methodology on any standard microprocessor-based gaming machine by means of appropriate programming.

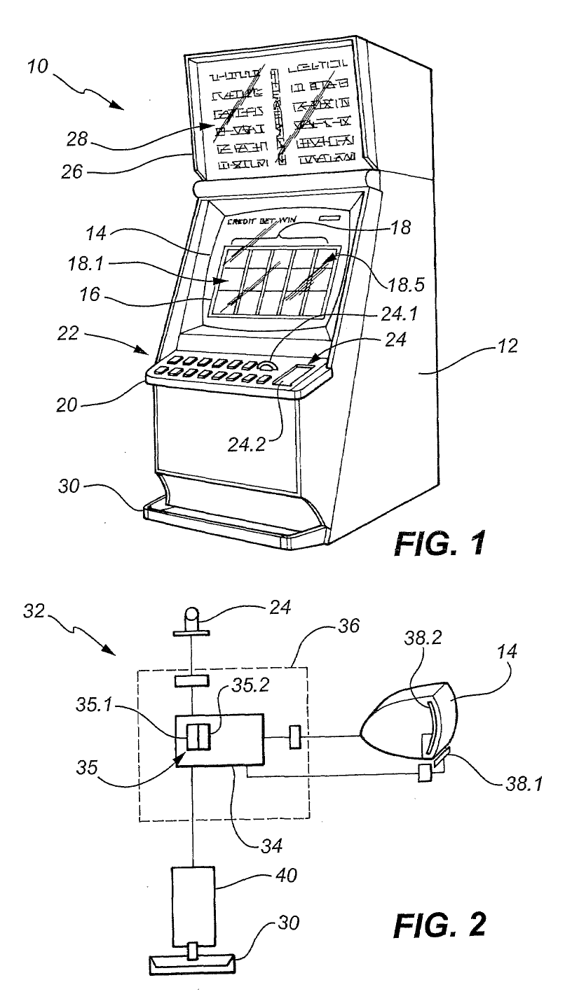

In FIG. 1, reference numeral 10 generally designates a gaming machine, including a game. The machine 10 includes a console 12 having a display means in the form of a video display unit 14 on which a game 16 is played in use. The video display unit 14 may be implemented as a cathode ray screen device, a liquid crystal display, a plasma screen, or the like. The game 16 is a spinning reel game which simulates the rotation of a number of spinning reels 18, preferably five. A mid-trim 20 of the machine 10 houses a keypad 22 containing buttons for enabling a player to play the game 16. The mid-trim 20 also houses a credit input mechanism 24 including a coin input chute 24.1 and a bill collector 24.2.

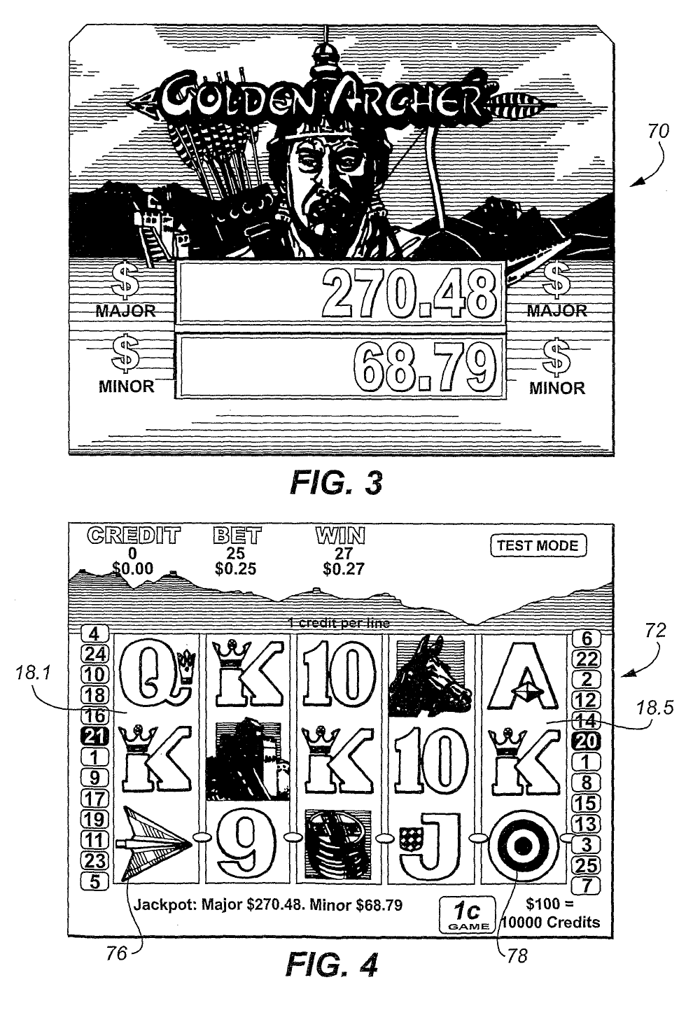

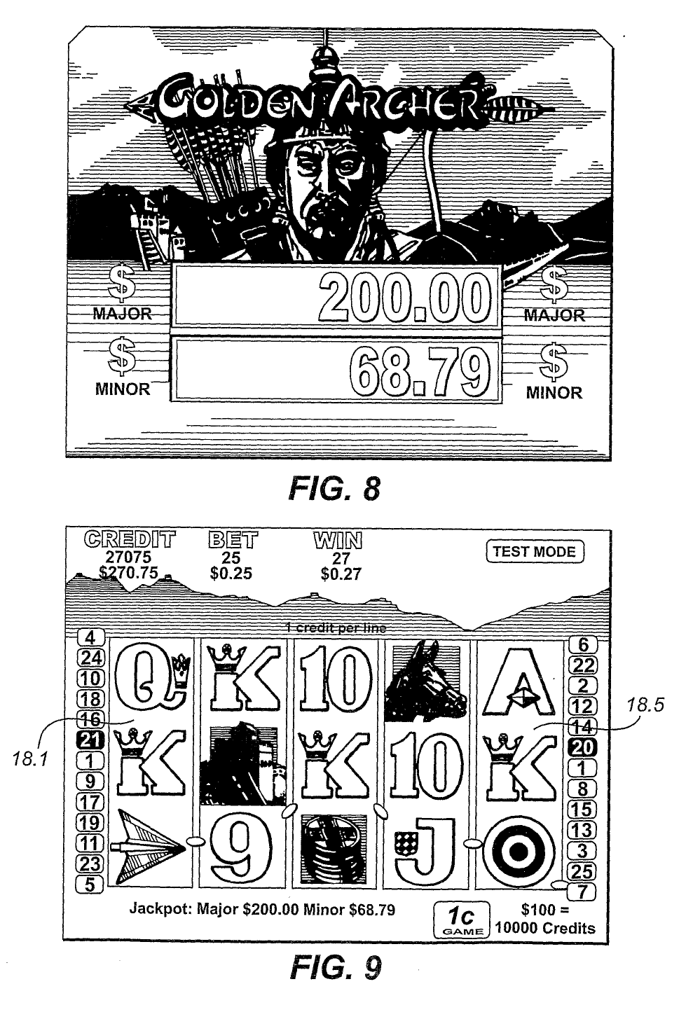

The machine 10 includes a top box 26 on which artwork 28 and major and minor jackpot amounts is carried. The artwork 28 may include pay tables, details of bonus awards, etc. FIGS. 3 and 8 depict one example of the top box in more detail showing details of major and minor jackpots to be won on the machine. A coin tray 30 is mounted beneath the console 12 for cash payouts from the machine 10.

Referring to FIG. 2 of the drawings, a control means or control circuit 32 of the gamine machine 10 is illustrated. A program which implements the game and user interface is run on a processor 34 of the control circuit 32. The processor 34 includes a memory device 35 and forms part of a controller 36 that drives the screen of the video display unit 14 and that receives input signals from sensors, which include sensors 38.1 associated with the keypad 22 and touch sensors 38.2 mounted in the screen of the video display unit 14. The controller 36 also receives input pulses from the mechanism 24 to determine whether or not a player has provided sufficient credit to commence playing. The mechanism 24 may, instead of the coin input chute 24.1 or the bill collector 24.2, or in addition thereto, be a credit card reader (not shown) or any other type of validation device. The memory device 35 includes RAM 35.1 for storing event and other data generated in the course of the game, and ROM or EPROM 35.2 for storing program code which controls the operation rules and pay tables of the game.

Finally, the controller 36 drives a payout mechanism 40 which, for example, may be a coin hopper for feeding coins to the coin tray 30 to make a payout to a player when the player wishes to redeem his or her credit.

FIG. 3 depicts the upper screen or top box 28 for the “Golden Archer” game. This screen indicates the major and minor jackpot amounts which may be won during play so as to attract potential players. The jackpots are progressive jackpots which increase as the base game is played. The machine 40 is a stand alone game where the jackpots are not linked to any other machines, and a percentage of the wager of each play contributes to the size of the major and minor jackpots. A pay table will determine the prize awarded for a particular combination of symbols. Of course, the game could be a linked progressive game.

As is well known with these types of gaming machines, the player plays a base game, which is depicted on the lower screen 14. In the present embodiment the base game comprises a video representation of spinning reels, which are stopped at random. The base game is arranged to pay a prize on the occurrence of a predetermined symbol or combination of symbols. In the present embodiment the first reel 18.1 and the fifth reel 18.5 each include a special symbol, in this embodiment an arrow symbol 76 on the first reel 18.1, and a target symbol 78 on fifth reel 18.5. When these two symbols appear together on the same line that indicates the start of a feature event which is described in more detail below. One or both of the arrow 76 and target 78 may be wild symbols and can therefore increase the prize awarded in the base game. More importantly, the appearance of these symbols on the same line indicates the start of the feature event.

The chance that both symbols 76 and 78 will appear on the same line is relatively remote, that is, it is intended that this occurs infrequently in typical play. This allows the prizes to be associated with the occurrence to be relatively high. To give a generalised example, consider that if there are five spinning reels, and three rows of symbols shown on one screen, each reel having 30 symbols with one arrow on the first reel plus one target on the fifth reel, then the probability of triggering the feature event in the base game would be 3*[(1/30)*1*1*1*(1/30)]=0.00333 (or 1 in 300).

When the arrow and target appear on the same line, as depicted by the lower line in FIG. 4, that triggers the start of the feature event. The game controller is programmed to award the player one of a plurality of possible feature outcomes at this point. However, rather than simply awarding the feature outcome, added suspense is created for the player by causing the two symbols 76 and 78 to animate in the manner described below. That animation may happen automatically, or may require player intervention at some point in the animation sequence in order for the animation sequence to be completed, and the feature outcome awarded to the player. Typically, since the gaming machine comprises a video representation of a spinning reel game the game controller will operate, in broad terms, as follows. Once the two symbols 76 and 78 have appeared on the same line, indicating the start of a feature event, the game controller will select an outcome of that feature. The selection is a weighted random selection, in which the highest prize award will typically have the lowest probability of being awarded, and the lowest outcome prize having the highest probability of being awarded. Once the outcome has been selected by the game controller it will cause a video representation of that outcome to be played on the screen 14 as described in more detail below.

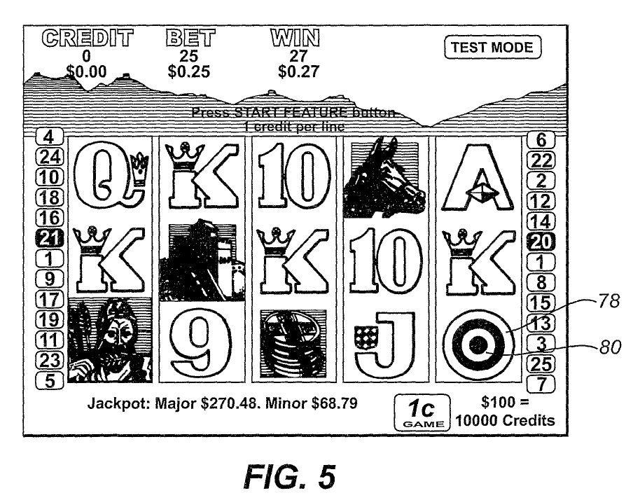

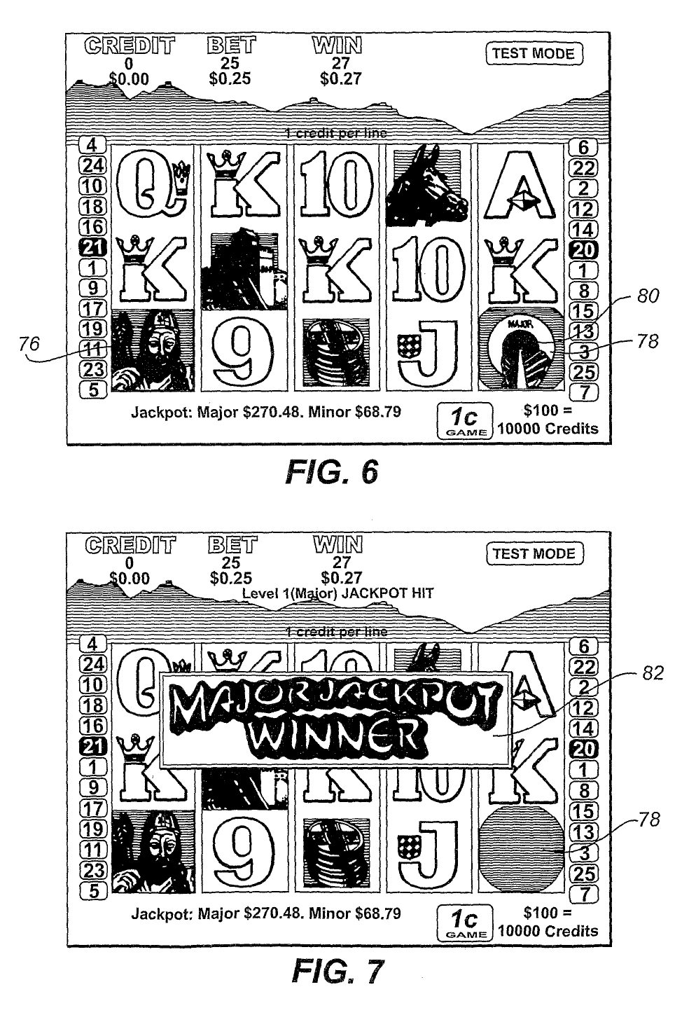

The player may interact with the feature event by pressing the “start feature” button. Synchronised animations will then be played on the two symbols 76, 78. As can be seen from an examination of FIGS. 4 through 7, the animation of the first symbol 76 shows the archer releasing the arrow, while the animation of the second symbol 78 shows the arrow hitting the target. It can be seen in FIGS. 4 and 5 that the target 78 has four concentric rings surrounding a bullseye centre.

The bullseye and the rings of the second symbol 78 correspond to each of the possible feature prizes and thus, the animation of the second symbol 78 will show the arrow hitting the target ring or bullseye according to the feature outcome previously selected by the game controller. The table below indicates the correspondence between the feature prize and the target ring hit by the arrow.

TABLE 1
Correspondence of target ring to feature prize

| Target Ring | Win (1 Credit) |
|---|---|
| 1 | 2 |
| 2 | 5 |
| 3 | 10 |
| 4 | MINOR JACKPOT |
| Bullseye | MAJOR JACKPOT |

The odds of each of the various prizes being awarded are not the same and may be determined by a random weighting table. As an example, the random weighting table for each of the feature prizes could be as follows:

TABLE 2
Random weighting table

| Target Ring | Probability |
|---|---|
| 1 | 0.50 |
| 2 | 0.25 |
| 3 | 0.10 |
| 4 | 0.10 |
| Bullseye | 0.05 |

Thus, the probability of winning the major jackpot from a single base game spin of the reels would be the probability of the feature event being awarded times the probability of the feature outcome being the major prize. In the example discussed above, the feature event had a 1 in 300 chance of being awarded for each play of the base game. In the table above the bullseye has a 1 in 20 (0.05) chance of being hit during the play of the feature event. The chance of the major jackpot being awarded is thus 0.00333 times 0.05 which equals approximately 0.00017 or approximately 1 in 6000. It will be appreciated that this calculation is merely illustrative of how the probability of each of the feature outcomes being won can be calculated.

The above examples are exemplary only and could vary according to client specifications, industry standards or regulatory controls.

FIG. 7 illustrates the final animation of the second symbol 78 with a banner 82 announcing the major jackpot win. FIG. 8 then illustrates the top box screen 28 showing the updated progressive jackpot amounts with the major jackpot having been reduced as a result of being awarded.

The display screen then progresses to that shown in FIG. 9 where the major jackpot amount has been credited directly to the credit meter rather than first going to the win meter. This is in accordance with regulatory requirements. In some circumstances, although not included in the present embodiment, a double-up feature may be offered to amounts on the win meter. By directly transferring the progressive prize amounts to the credit meter, it is ensured that the double-up feature is not offered on feature prize amounts.

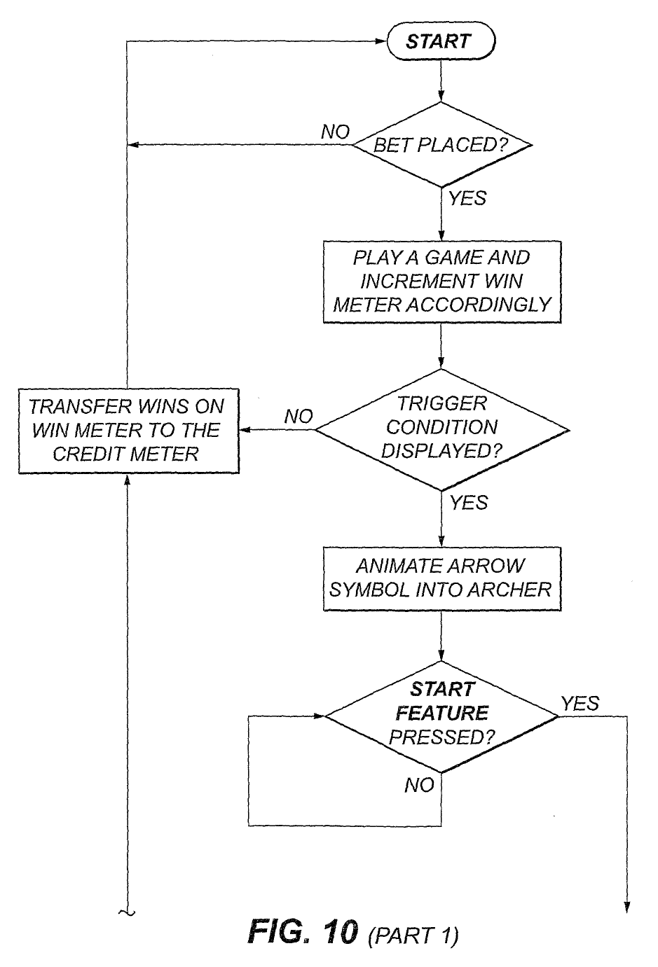

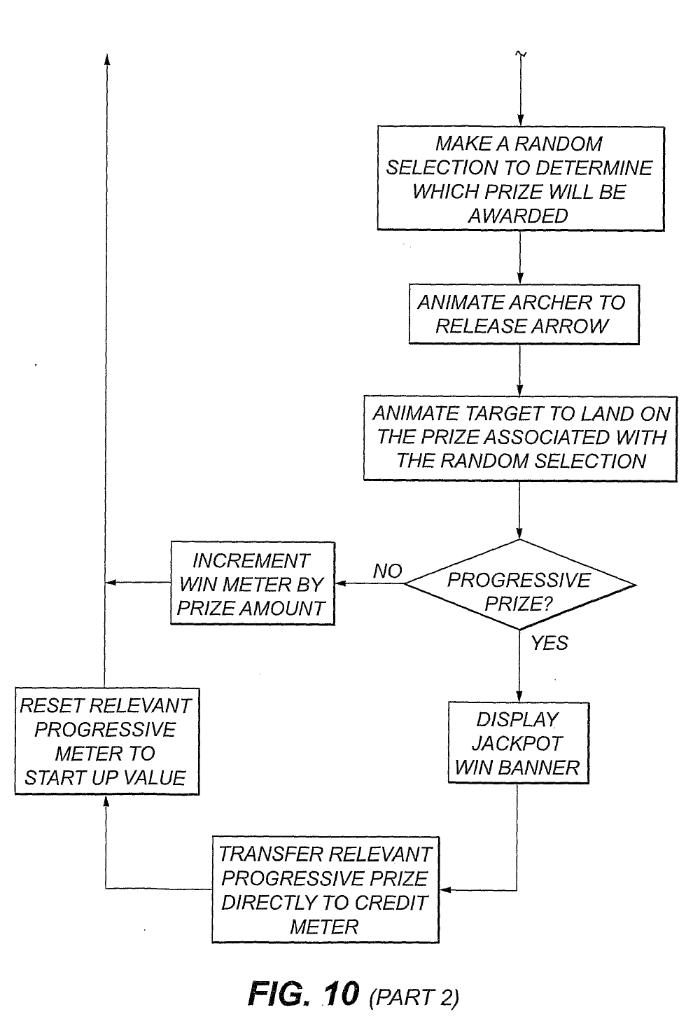

FIG. 10 diagrammatically illustrates the processes of the game control means.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive. One alternative, for example, is for more than two symbols to interact during the feature event in order to represent a feature outcome. Specifically envisaged is a feature event that requires three special symbols to be present on the screen to initiate the feature event. In such a situation one symbol may contribute one animation, another symbol may contribute another animation, and these two animations combine to represent an outcome at the third symbol.

1. A gaming machine having a display and a game controller arranged to control images displayed on the display, the game controller being arranged to play a game wherein symbols are randomly selected from a set of symbols, and selected symbols are displayed on the display means and, if a winning combination of symbols results, the machine awards a prize, and wherein the range of symbols includes at least one predetermined first symbol and at least one predetermined second symbol, such that on the selection and display of the first and second symbols in a predetermined manner, a feature event is awarded, the feature event being adapted to result in one of a plurality of feature outcomes, the game controller being arranged during the feature event to animate the first and second symbols on the display to give the appearance of interaction between the first and second symbols, there being a plurality of different interactions which reflect different feature outcomes.

2. A gaming machine according to claim 1 which includes player interaction means operable to initiate, or for intervention during, the feature event.

3. A gaming machine according to claim 2 wherein the player interaction means is adapted to initiate or cause resumption of interaction between the first and second symbols.

4. A gaming machine according to claim 1 wherein a feature outcome is a progressively increasing jackpot.

5. A gaming machine according to claim 1 wherein the feature outcome is randomly selected.

6. A gaming machine according to claim 5 wherein the odds of winning each possible feature outcome varies as determined by a feature outcome weighting table.

7. A gaming machine according to claim 1 wherein the animation gives the appearance of requiring an element of skill in order to be awarded at least some of the feature outcomes.

8. A gaming machine according to claim 7 wherein the first symbol comprises a projectile and the second symbol comprises a target with a number of zones corresponding to the range of possible feature outcomes.

9. A gaming machine according to claim 8 wherein one of the target zones comprises a premium winning zone, and in the event that the game controller has determined that the highest feature outcome is to be awarded, then the visual interaction shows the projectile hitting the premium winning zone of the target.

10. A gaming machine according to claim 1 wherein the machine is linked to other machines and all of the linked machines are eligible to win a linked progressive jackpot, one of the feature outcomes being the award of said linked progressive jackpot.

11. A gaming machine according to claim 2 wherein the player interaction means is adapted to affect the timing of some part of the animation, or the direction and speed of the animation.

12. A gaming machine according to claim 1 wherein the interaction of the first and is given by the appearance of a departing object which departs from the first symbol and arrives at the second symbol.

13. A gaming machine according to claim 12 in which the first symbol animates to give the appearance of the release of a projectile while the second symbol animates to give the appearance of the projectile striking a target zone depicted in the second symbol.

14. A gaming machine according to claim 13 wherein the timing of the respective animations of the first and second symbols, and the speed at which the projectile image is appearing to move, provides the appearance of the projectile departing from the first symbol and arriving at the second symbol.

15. A gaming machine according to claim 14 wherein at the end of the animation sequence but prior to the end of the feature event the projectile is shown having struck a target zone in the second symbol, thereby indicating the feature outcome awarded during the feature event.

16. A gaming machine according to claim 15 wherein the second symbol comprises a series of concentric rings, each ring defining a separate target zone.

17. A gaming machine according to claim 1 wherein the game is a video type spinning reel game, and the first and second symbols are located on separate reels.

18. A gaming machine according to claim 17 wherein the first and second symbols are located on non-adjacent reels.

19. A software program configured to control the operation of a game played on a gaming machine, the gaming machine having a display and a game controller arranged to control images displayed on the display, the game controller being arranged to play a game wherein symbols are randomly selected from a set of symbols, and selected symbols are displayed on the display means and, if a winning combination of symbols results, the machine awards a prize, and wherein the range of symbols includes at least one predetermined first symbol and at least one predetermined second symbol, such that on the selection and display of the first and second symbols in a predetermined manner, a feature event is awarded, the feature event being adapted to result in one of a plurality of feature outcomes, the game controller being arranged during the feature event to animate the first and second symbols on the display to give the appearance of interaction between the first and second symbols, there being a plurality of different interactions which reflect different feature outcomes.

20. A data storage means storing thereon a software program as claimed in claim 19.

21. (canceled)
